(19) United States
(12) Patent Application Publication
(10) Pub. No.: US 2015/0077786 A1
(43) Pub. Date: Mar. 19, 2015

(54) SELECTION DEVICE, IMAGE FORMING SYSTEM INCORPORATING SAME, AND SELECTION METHOD

(71) Applicant: Tadashi Tenda, Tokyo (JP)

(72) Inventor: Tadashi Tenda, Tokyo (JP)

(73) Assignee: RICOH COMPANY, LTD., Tokyo (JP)

(21) Appl. No.: 14/486,866

(22) Filed: Sep. 15, 2014

(30) Foreign Application Priority Data
Sep. 17, 2013 (JP) 2013191619
Aug. 20, 2014 (JP) 2014167464

(51) Int. Cl. G06F 3/12

(52) U.S. Cl. CPC G06F 3/121; G06F 3/1259
USPC 358/1.14

(57) ABSTRACT

A selection device, an image forming system incorporating the same, and a selection method are provided. Each of the selection device and the selection method obtains defect information of defect on an output result of image forming, from each of a plurality of image forming apparatuses, receives an image formation instruction, generates defect rate information based on the obtained defect information and the image formation instruction, the generated defect rate information indicating a rate of occurrence of a defect by category of defect for each of the image forming apparatuses, and specifies a category corresponding to the image formation instruction, and selecting one of the image forming apparatuses that is to perform image forming based on the image formation instruction, according to the defect rate information corresponding to the specified category.

### CROSS-REFERENCE TO RELATED APPLICATIONS

This patent application is based on and claims priority pursuant to 35 U.S.C. §119(a) to Japanese Patent Application Nos. 2013-191619 and 2014-167464, filed on Sep. 17, 2013, and Aug. 20, 2014, respectively, in the Japan Patent Office, the entire disclosure of which is hereby incorporated by reference herein.

### BACKGROUND

1. Technical Field

Example embodiments of the present invention generally relate to a selection device, an image forming system incorporating the same, and a selection method.

2. Background Art

In recent years, there has been a trend toward converting information into electronic form. As a result, image processing apparatuses such as printers and fax machines that are used to output the digitized information, and image processing apparatuses such as scanners that are used to digitize documents, have become indispensable. Such image processing apparatuses are usually provided with an imaging capability, an image forming capability, a communication capability, or the like, and are configured as an MFP (multifunction peripheral) that can be used as a printer, facsimile, scanner, or copier.

Regarding such image processing apparatuses, printers that perform printing based on the print jobs generated by information processing devices such as personal computers (PCs) are widely used for outputting digitized documents. Further, an inspection device may be connected to one or more printers, which determines whether the printed material output from each printer is defective. Such information regarding the defect may be used, for example, by a controller device that controls the printers to select a printer that is suitable for performing a print job.

### SUMMARY

Embodiments of the present invention described herein provide an improved selection device, image forming system incorporating the same, and selection method. Each of the selection device the selection method obtains defect information of defect on an output result of image forming, from each of a plurality of image forming apparatuses, receives an image formation instruction, generates defect rate information based on the obtained defect information and the image formation instruction, the generated defect rate information indicating a rate of occurrence of a defect by category of defect for each of the image forming apparatuses, and specifies a category corresponding to the image formation instruction, and selecting one of the image forming apparatuses that is to perform image forming based on the image formation instruction, according to the defect rate information corresponding to the specified category.

### BRIEF DESCRIPTION OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 is a block diagram illustrating the configuration of an image forming system according to an example embodiment of the present invention.

FIG. 2 is a block diagram illustrating the hardware configuration of a device or apparatus according to an example embodiment of the present invention.

FIG. 3 illustrates a model of comparison according to an example embodiment of the present invention.

FIG. 4 depicts an example of defect information according to an example embodiment of the present invention.

FIG. 5 is a block diagram illustrating the functional configuration of a print control device according to an example embodiment of the present invention.

FIG. 6 depicts an example of defect rate information according to an example embodiment of the present invention.

FIG. 7 is a flowchart of the processes of generating defect rate information according to an example embodiment of the present invention.

FIG. 8 depicts an example of threshold characteristic amount information according to an example embodiment of the present invention.

FIG. 9 is a flowchart of the processes of selection according to an example embodiment of the present invention.

FIG. 10 depicts an example of classification information according to an example embodiment of the present invention.

FIG. 11 is a sequence diagram illustrating the operation of an image forming system according to an example embodiment of the present invention.

FIG. 12 depicts an example of defect rate information according to a second modification of the present invention.

FIG. 13 depicts an example of defect information according to a third modification of the present invention.

FIG. 14 depicts an example of defect information according to a fourth modification of the present invention.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits (ASICs), field programmable gate arrays (FPGAs) computers or the like. These terms in general may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Example embodiments of the present invention will be described below in detail with reference to the drawings. In the present example embodiment, an image forming system is described including an information processing device that generates and transmits a print job (i.e., an example of an image formation instruction), a plurality of image forming apparatuses that form an image based on the print job generated by the information processing device, and a print control device (i.e., an example of a selection device) that controls the selected image forming apparatus to perform the print job transmitted from the information processing device. Note that an inspection device that inspects the output results of image forming and outputting processes is connected to each of the image forming apparatuses.

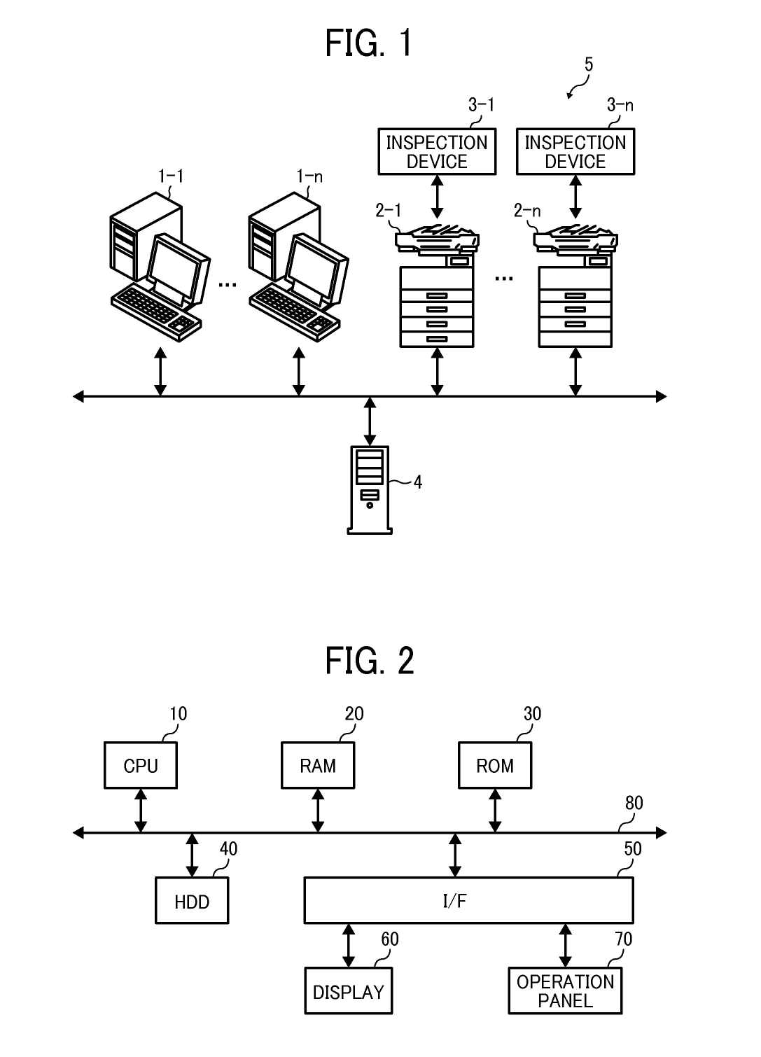

FIG. 1 is a block diagram illustrating an image forming system 5 according to an example embodiment of the present invention. As illustrated in FIG. 1, the image forming system 5 according to the present example embodiment includes n information processing devices 1-1 to 1-n, n image forming apparatuses 2-1 to 2-n, and a print control device 4. Note that “n” indicates an integer that is equal to or greater than one, and “n” may indicate a different number among different devices or apparatuses. Hereinafter, the n information processing devices 1-1 to 1-n and the n image forming apparatuses 2-1 to 2-n may be referred to simply as the information processing device 1 and the image forming apparatus 2, respectively. The information processing device 1, the image forming apparatus 2, and the print control device 4 are connected to each other through the network. Note that inspection devices 3-1 to 3-n are connected to the image forming apparatuses 2-1 to 2-n, respectively. In the following description, the inspection devices 3-1 to 3-n are referred to simply as “inspection device 3”.

The information processing device 1 is an information processing terminal operated by a user, and is realized, for example, by a personal computer (PC). The information processing device 1 according to the present example embodiment generates a print job according to the operation made by a user, and transmits the generated print job to the print control device 4 through the network so as to make one of the image forming apparatuses 2 perform image forming and outputting processes. Note that the print job according to the present example embodiment includes setting information and a threshold defect level. The setting information relates to the configuration of the image forming and outputting processes that are based on a print job. For example, the setting information includes color mode information indicating monochrome printing or full color printing, and printing side information indicating single-sided printing or duplex printing. The threshold defect level is a defect level indicating a threshold for determining a defect level to be defective from a plurality of defect levels. For example, when there are five defect levels 1 to 5 and the threshold defect level indicates the defect level 3, the defect levels equal to or greater than the defect level 3 (i.e., the defect levels 3 to 5) are determined to be defective. The threshold defect level may be attached to the print job that is transmitted to the print control device 4.

The image forming apparatus 2 is usually provided with an imaging capability, an image forming capability, a communication capability, or the like, and are configured as a multifunction peripheral (MFP) that can be used as a printer, facsimile, scanner, or copier. However, the image forming apparatus 2 is not limited to this configuration, but may have a different configuration as long as the image forming apparatus 2 can perform image forming and outputting processes. The image forming apparatus 2 according to the present example embodiment is capable of performing image forming and outputting processes based on the print job generated by the information processing device 1. Moreover, the image forming apparatus 2 transmits the defect information related to the defect present on the output result of the image forming and outputting processes to the print control device 4. The details of the defect information are described later.

The inspection device 3 inspects the output results of image forming and outputting processes by comparing a master image with a scanned image obtained by scanning an output result (i.e., a printed material) of the connected image forming apparatus 2. The operation of the inspection device 3 according to the present example embodiment is described later in detail. When a defect is detected in the output result of the image forming and outputting processes as a result of the comparison between the master image and the scanned image, the inspection device 3 transmits the defect information to the image forming apparatus 2. By so doing, the image forming apparatus 2 can control the re-printing of a defective page.

The print control device 4 accumulates the defect information sent from the image forming apparatus 2. When the print job sent from the information processing device 1 is received, the print control device 4 selects the image forming apparatus 2 that is to perform image forming and outputting processes based on the received print job from the n image forming apparatuses 2 in accordance with the stored defect information and the received print job, and sends the print job to the selected image forming apparatus 2. In other words, the print control device 4 controls the image forming apparatus 2 selected from the image forming apparatuses 2 to perform image forming and outputting processes. The operation of the print control device 4 according to the present example embodiment is described later in detail.

Next, an example of the hardware configuration of the information processing device 1, the image forming apparatus 2, the inspection device 3, and the print control device 4 according to the present example embodiment is described with reference to FIG. 2. In addition to the hardware configuration illustrated in FIG. 2, the image forming apparatus 2 includes an engine for realizing a scanner, a printer, or the like. In addition to the hardware configuration illustrated in FIG. 2, the inspection device 3 includes a processing device dedicated to perform image processing at high speed. Such a processing device is configured as, for example, an application-specific-integrated-circuit (ASIC). Moreover, the inspection device 3 includes a reading device such as a scanner that scans the image formed on paper.

As illustrated in FIG. 2, the devices and apparatuses according to the present example embodiment includes a configuration similar to that of ordinary information processing devices such as personal computers (PCs) and servers. In other words, a central processing unit (CPU) 10, a random access memory (RAM) 20, a read only memory (ROM) 30, a hard disk drive (HDD) 40, and an interface (I/F) 50 are connected to each other via a bus 80 in the devices and apparatuses according to the present example embodiment of the present invention. Moreover, the I/F 50 is connected to a liquid crystal display (LCD) 60 and an operation panel 70.

The CPU 10 serves as a computation unit, and controls the entire operation of the device or apparatus. The RAM 20 is a volatile storage medium capable of reading and writing data at high speed, and is used as a working area when the CPU 10 processes data. The ROM 30 is a read-only nonvolatile storage medium in which firmware programs or the like are stored. The volatile HDD 40 is a data readable/writable nonvolatile storage medium in which an OS (operating system), various kinds of control programs, applications, programs, or the like are stored.

The I/F 50 connects various kinds of hardware, networks, or the like to the bus 80, and controls these elements. The LCD 60 is a visual user interface used to monitor the state of the device or apparatus. The operation panel 70 is a user interface such as a keyboard or a mouse used to input data to the device or apparatus.

In such a hardware configuration, programs stored on the ROM 30, the HDD 40, or in another storage medium such as an optical disk are read by the RAM 20, and the CPU 10 performs computation according to these programs read on the RAM 20. This series of processes configures a software controller. The software controller as configured above and hardware are combined to configure a functional block that realizes the functions of the information processing device 1, the image forming apparatus 2, the inspection device 3, and the print control device 4 according to the present example embodiment of the present invention.

Next, the operation of the image forming apparatus 2 and the inspection device 3 when the inspection device 3 inspects the output results of image forming and outputting processes is described. The image forming apparatus 2 generates image data to be printed out, i.e., the bit map data of an image to be output, based on the received print job, and transmits the generated bit map data to the inspection device 3. The inspection device 3 generates a master image based on the bit map data received from the image forming apparatus 2. Then, the inspection device 3 inspects the output results of the image forming and outputting processes performed by the image forming apparatus 2, by comparing the above-generated master image with a scanned image obtained by scanning by using a scanning device the printed material generated in image forming and outputting processes based on the bit map data generated by the image forming apparatus 2.

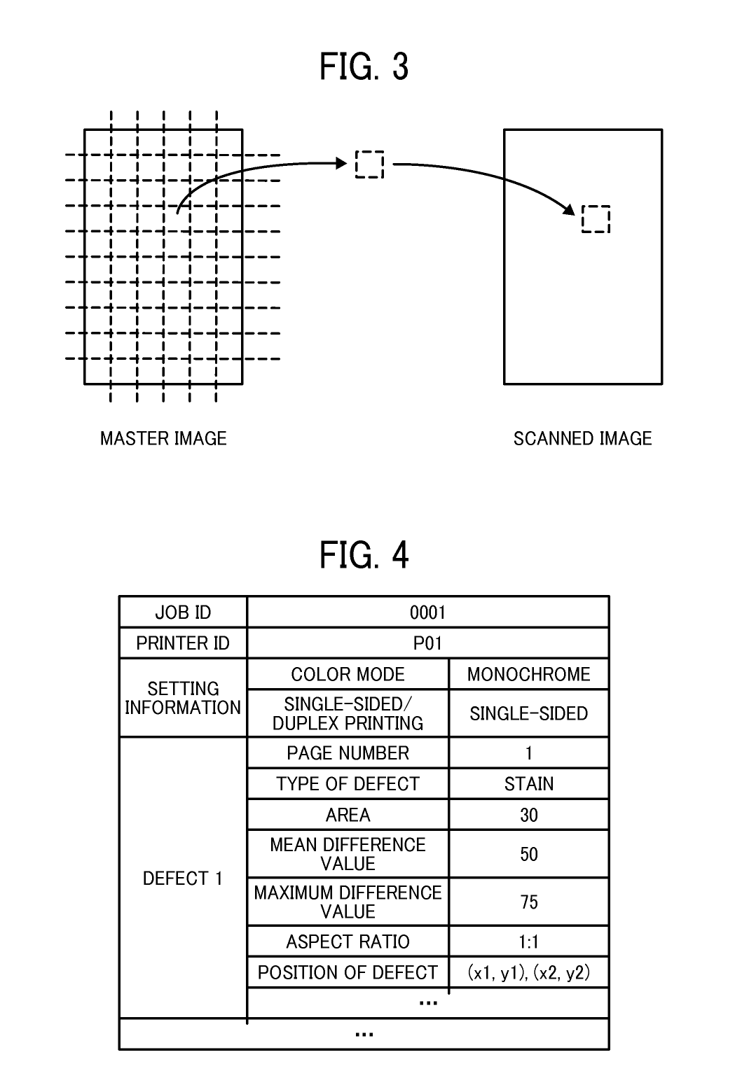

More specifically, the inspection device 3 compares the scanned image, which is scanned where each color of RGB is expressed by 8 bits, with a master image for each corresponding pixel, and calculates a difference between the pixel value of each color of RGB expressed by 8 bits and the pixel value of the master image, on a pixel-by-pixel basis. Based on the comparison between the calculated difference and a threshold, the inspection device 3 determines whether or not a scanned image is defective. FIG. 3 illustrates a model of comparison according to the present example embodiment of the present invention. When a scanned image is compared with a master image, the inspection device 3 calculates a difference in pixel value, i.e., a difference in density, of each pixel by superimposing a piece of the scanned image divided into specified ranges on the corresponding area of the master image, as illustrated in FIG. 3. Further, the inspection device 3 shifts the position at which the divided piece is superimposed on the corresponding area of the scanned image vertically and horizontally, and determines the position at which the calculated difference becomes smallest to be an accurate superimposition point and adopts the calculated difference therein as a comparison result. By performing these processes as described above, a difference is calculated upon aligning a scanned image with a master image.

Regarding a method of comparing a difference with a threshold, the inspection device 3 according to the present example embodiment of the present invention compares a difference calculated for each pixel with a predetermined threshold. By so doing, the inspection device 3 obtains data indicating whether or not a per-pixel difference between a scanned image and the corresponding master image exceeds a specified threshold, as a result of the comparison. In other words, it becomes possible to inspect whether or not each of the pixels of the scanned image is defective. As described above, the inspection device 3 inspects the scanned image according to a threshold, and the image forming apparatus 2 can perform re-printing processes according to the result of the inspection.

Upon inspecting the scanned image according to a threshold as described above, the inspection device 3 generates defect information that indicates the details of one recognized-unit of defect, and sends the generated defect information to the image forming apparatus 2. It is assumed that the threshold used in the present example embodiment is set to a minimum defect level (for example, the defect level 1 descried above), but no limitation is indicated therein. The image forming apparatus 2 updates the defect information by adding the identifier of the print job, the identifier of the image forming apparatus 2 itself, and the setting information included in the print job of the image forming and outputting processes whose output result has been inspected to the inspection device input from the inspection device 3, and sends the updated defect information to the print control device 4. In other words, the image forming apparatus 2 and the inspection device 3 connected to the image forming apparatus 2 together serve as a defect information generator.

FIG. 4 depicts an example of the defect information sent to the print control device 4, according to the present example embodiment of the present invention. As depicted in FIG. 4, the defect information includes, for example, a job identification (ID) that is an identifier for identifying the print job for which an image is formed and output by the image forming apparatus 2 and the output from the image forming apparatus 2 is inspected by the inspection device 3, a printer ID that is an identifier for identifying the image forming apparatus 2 that has caused the defect in the image forming process, the setting information of the print job (image formation) identified by the job ID, and the details of each unit of defect (as an example of information that can determine the number of defects).

The unit of defect is a unit that is recognized as one defect, and is recognized, for example, by labeling an image that is determined to be defective on a page. As depicted in FIG. 4, a defect includes a type of defect, a position of defect indicating the position where a difference exceeding a threshold is calculated on a scanned image, an amount of characteristic including the area of a labeled connected component at the position of defect, a maximum difference value, and an aspect ratio, and a page number of a page that includes a defect. Note that the type of defect is determined by the amount of characteristic. For example, when the aspect ratio is greater than a predetermined aspect ratio (for example, 1:5), the type of defect is determined to be “stripe”. Moreover, when the position of defect indicates the entire page or the area is almost equal to the size of paper, it is considered that a master image does not match a scanned image in its entirety and the type of defect is determined to be “misregistration”.

In the example embodiment described above, cases in which the image forming apparatus 2 obtains defect information from the inspection device 3 and updates and transmit the obtained defect information are described. However, the inspection device 3 may obtain the identifier of a print job, the identifier of the image forming apparatus 2, and the setting information of the print job, and send the updated defect information to the print control device 4.

The print control device 4 selects one of the image forming apparatuses 2 according to the received defect information and the print job sent from the information processing device 1, and controls the selected image forming apparatus 2 to perform image forming and outputting processes based on the print job. Next, the functional configuration of the print control device 4 according to the present example embodiment is described.

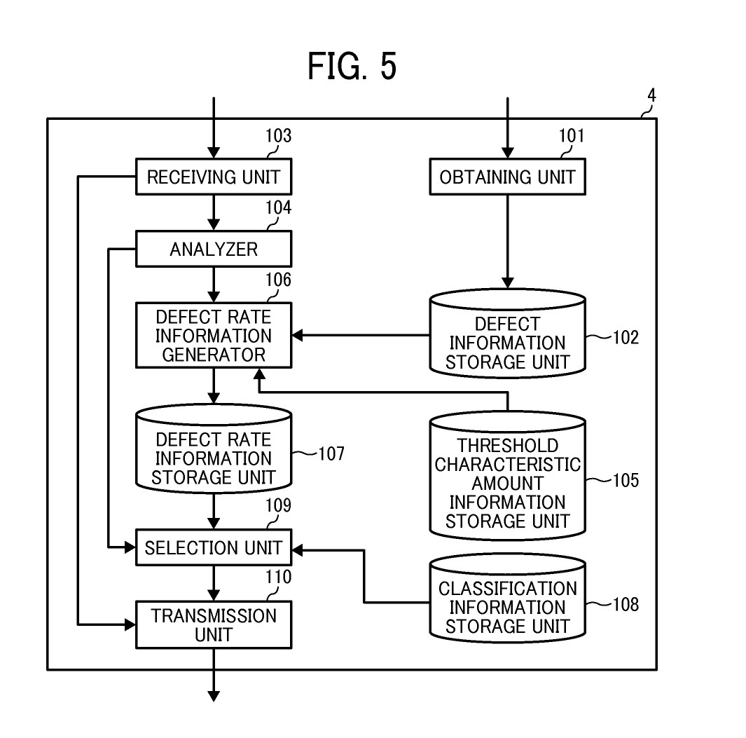

FIG. 5 is a block diagram illustrating the functional configuration of the print control device 4 according to the present example embodiment of the present invention. As illustrated in FIG. 5, the print control device 4 according to the present example embodiment includes an obtaining unit 101, a defect information storage unit 102, a receiving unit 103, an analyzer 104, a threshold characteristic amount information storage unit 105, a defect rate information generator 106, a defect rate information storage unit 107, a classification information storage unit 108, a selection unit 109, and a transmission unit 110.

The obtaining unit 101 obtains defect information from each of the image forming apparatuses 2. In the present example embodiment, the obtaining unit 101 obtains the defect information as depicted in FIG. 4 from the image forming apparatuses 2, and stores in the defect information storage unit 102. The defect information storage unit 102 is a storage medium for storing the defect information obtained by the obtaining unit 101. In other words, the defect information of the materials that have been printed by the image forming apparatuses 2 is stored in the defect information storage unit 102.

The receiving unit 103 receives a print job from the information processing device 1, and sends it to the analyzer 104 and the transmission unit 110.

The analyzer 104 analyzes the print job sent from the receiving unit 103. More specifically, the analyzer 104 analyzes the print job to extract setting information and a threshold defect level therefrom, and sends the extracted setting information and threshold defect level to the selection unit 109 and the defect rate information generator 106, respectively.

The defect rate information generator 106 generates defect rate information based on the defect information obtained by the obtaining unit 101 and the print job received by the receiving unit 103. The generated defect rate information indicates the rate of occurrence of a defect for each of the image forming apparatuses 2 and for each category of defect. More specifically, the defect rate information generator 106 generates defect rate information by summing up the number of the defects indicated by the obtained defect information for each of the image forming apparatuses 2 and for each category of defect, and by dividing the summed up value by the total number of times images have been formed by that image forming apparatus 2. In the example embodiment described above, the category of defect indicates the type of defect. However, no limitation is indicated therein.

More specifically, the defect rate information generator 106 obtains threshold characteristic amount information in which for each type of defect each of the defect levels is associated with a threshold characteristic amount indicating the threshold amount of characteristic for determining whether that defect level is defective, and generates defect rate information based on the defect information obtained by the obtaining unit 101 (i.e., the defect information stored in the defect information storage unit 102), the threshold defect level included in the print job received by the receiving unit 103 (i.e., the threshold defect level sent from the analyzer 104), and the obtained threshold characteristic amount information. In particular, the defect rate information generator 106 sums up the number of the defects whose defect levels specified by the threshold characteristic amount information are equal to or greater than a threshold defect level among the defects indicated by the obtained defect information, for each of the image forming apparatuses 2 and for each category of defect (i.e., the type of defect in the present example embodiment), and divides the summed up value by the total number of times images have been formed by that image forming apparatus 2, to generate defect rate information. The processes of generating defect rate information are described later in detail.

Note that the threshold characteristic amount information is stored in the threshold characteristic amount information storage unit 105, and the defect rate information generator 106 obtains the threshold characteristic amount information from the threshold characteristic amount information storage unit 105. The threshold characteristic amount information storage unit 105 is a storage medium for storing threshold characteristic amount information. The defect rate information generator 106 makes the defect rate information storage unit 107 store the generated defect rate information. The defect rate information storage unit 107 is a storage medium for storing the defect rate information generated by the defect rate information generator 106.

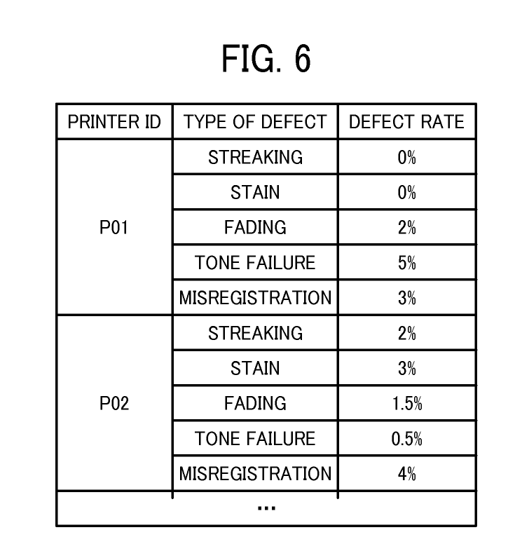

FIG. 6 depicts an example of the defect rate information stored in the defect rate information storage unit 107 according to the present example embodiment of the present invention. As depicted in FIG. 6, the defect rate information indicates a defect rate for each type of defect, for each printer ID. A defect rate indicates the rate of occurrence of defect, i.e., the rate at which a defect has occurred. A defect rate is calculated by dividing the number of times a particular type of defect has occurred for the same printer ID by the total number of times images have been formed for the same printer ID. As depicted in FIG. 6, the types of defect includes, for example, “streaking”, “stain”, “fading”, “tone failure”, and “misregistration”, and when the printer ID of the image forming apparatus 2 is “P01”, the defect rates of the types of defect are 0%, 0%, 2%, 5%, and 3%, respectively.

The selection unit 109 specifies the category (i.e., the type of defect in the present example embodiment) that corresponds to the print job based on the print job received by the receiving unit 103, and selects one of the image forming apparatuses 2 that is to perform image forming and outputting processes based on the print job received by the receiving unit 103, according to the specified category and the defect rate information generated by the defect rate information generator 106.

More specifically, the selection unit 109 obtains classification information in which the setting of image forming and outputting processes are associated with the corresponding categories, and specifies the category that corresponds to the setting indicated by the setting information input from the analyzer 104, according to the obtained classification information. More specifically, the selection unit 109 refers to the classification information, and specifies that the category associated with the setting indicated by the setting information is the category that corresponds to the setting. Note that the classification information is stored in the classification information storage unit 108, and the selection unit 109 obtains classification information from the classification information storage unit 108. The classification information storage unit 108 is a storage medium for storing the classification information.

Then, the selection unit 109 refers to the defect rate information stored in the defect rate information storage unit 107, and selects one of the image forming apparatuses 2 where the rate of occurrence of the defects of the specified category is the lowest. The processes of selecting the image forming apparatus 2 are described later in detail.

The transmission unit 110 transmits the print job sent from the receiving unit 103 to the image forming apparatus 2 selected by the selection unit 109. As the print control device 4 performs processes as described above, the selected image forming apparatus 2 can perform image forming and outputting processes based on the print job sent from the information processing device 1.

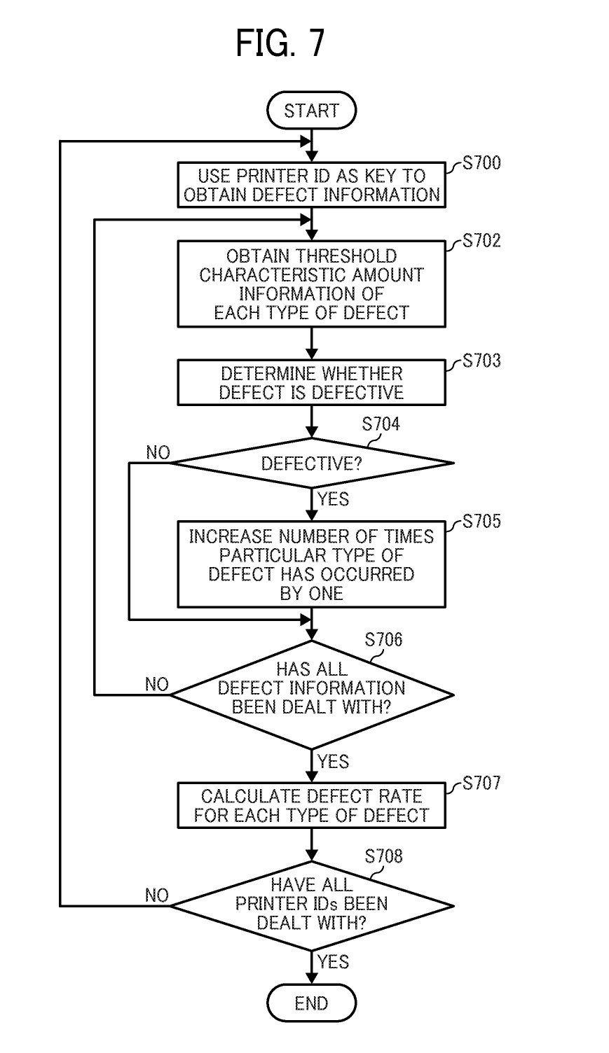

The processes of generating defect rate information by the defect rate information generator 106 as mentioned above are described in detail with reference to FIG. 7. FIG. 7 is a flowchart of the processes of generating defect rate information as depicted in FIG. 6 by the defect rate information generator 106, according to the present example embodiment of the present invention. As depicted in FIG. 7, the defect rate information generator 106 uses a printer ID as a key to obtain the defect information including the printer ID used as a key from the defect information stored in the defect information storage unit 102 (S700).

Then, the defect rate information generator 106 extracts not-yet-processed defect information from the obtained defect information, and obtains the threshold characteristic amount information of each type of defect indicated by the extracted defect information by referring to the threshold defect level sent from the analyzer 104 and the threshold characteristic amount information stored in the threshold characteristic amount information storage unit 105 (S702).

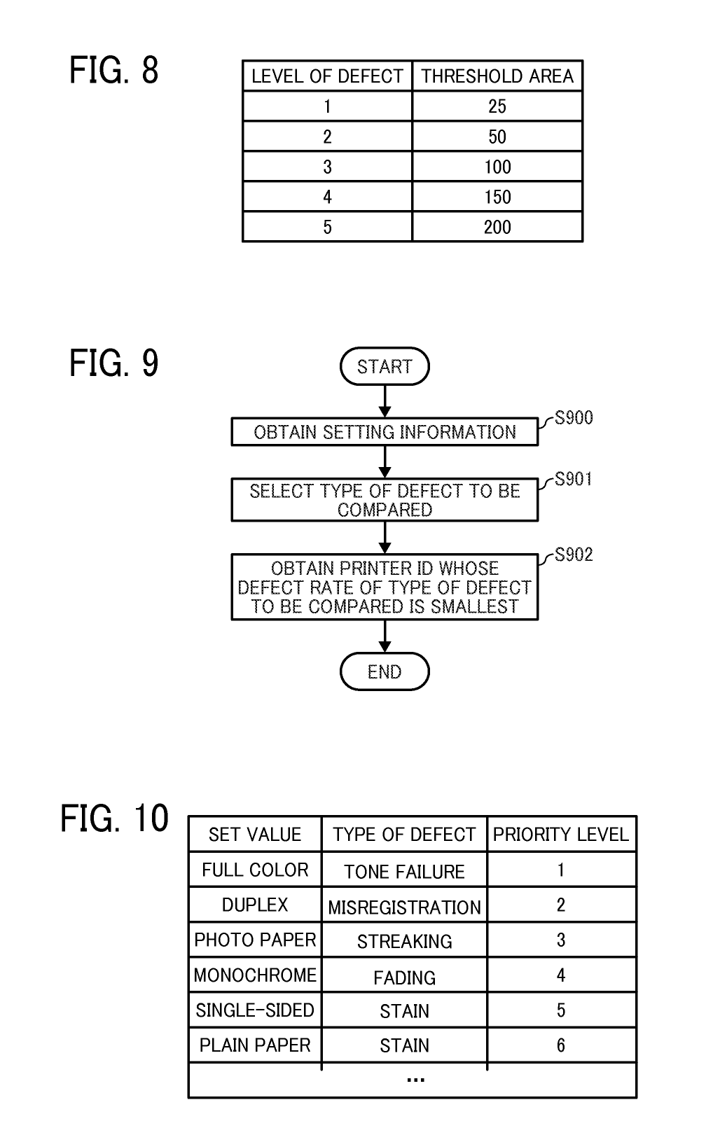

FIG. 8 depicts an example of the threshold characteristic amount information stored in the threshold characteristic amount information storage unit 105 according to the present example embodiment of the present invention. The threshold characteristic amount information is defined for each of the types of defect. For example, in the threshold characteristic amount information depicted in FIG. 8, whether or not a defect portion of particular type of defect (for example, “stain”) is defective is determined according to the area of the defect portion, and a threshold area is defined as a threshold characteristic amount that corresponds to each level of defect. For example, when the threshold defect level sent from the analyzer 104 is “3” and one of the types of defect indicated by the extracted defect information is “stain”, the defect rate information generator 106 obtains the threshold area “100” by referring to the threshold characteristic amount information depicted in FIG. 8.

Then, the defect rate information generator 106 compares the amount of characteristic of the defect identified by the extracted defect information with the threshold characteristic amount of the type of defect of that defect on a defect-by-defect basis, and determines whether the defect is defective (S703). For example, when the type of defect indicated by the defect information is “stain” and the threshold area “100” is obtained, the defect rate information generator 106 determines the defect to be defective when the area of the defect is equal to or greater than “100”. In other words, the defect rate information generator 106 specifies the defect level to which the amount of characteristic of a defect belongs by referring to the threshold characteristic amount information, and determines the defect to be defective when the specified defect level is equal to or greater than the threshold defect level.

When the result of the determination indicates “defective” (“Yes” in S704), the defect rate information generator 106 increases the number of the times that type of defect has occurred by one (S705). Then, the defect rate information generator 106 repeats the processes in S702 to S705 (“No” in S706) until all the defect information obtained in S700 has been dealt with (“Yes” in S706).

After dealing with all the defect information, the defect rate information generator 106 calculates the defect rate for each type of defect (S707). More specifically, the defect rate information generator 106 calculates the ratio of the number of times a defect of each type of defect has occurred to the total number of times printing has been performed, as a defect rate of each type of defect. Note that the total number of times printing has been performed may be, for example, the number of pieces of defect information obtained with the printer ID which was used as a key in S700 (i.e., the number of the jobs of the printer ID which was used as a key).

Then, the defect rate information generator 106 repeats the processes in S700 to S707 (“No” in S708) until the defect rate calculation processes for each type of defect are complete (“Yes” in S708) for all the image forming apparatuses 2 (or all the printer IDs) included in the image forming system 5. By performing these processes described above, the defect rate information generator 106 can generate defect rate information for each of the image forming apparatuses 2 as depicted in FIG. 6, as a result of the determination processes.

Next, the processes of selecting the image forming apparatus 2 by the selection unit 109 as mentioned above are described in detail with reference to FIG. 9. FIG. 9 is a flowchart of the processes of selecting the image forming apparatus 2 according to the present example embodiment of the present invention. As depicted in FIG. 9, the selection unit 109 obtains the setting information that is input from the analyzer 104 (S900). It is assumed that, for example, “full color”, “duplex printing”, “plain paper” are set in the setting information.

Then, the selection unit 109 refers to the classification information stored in the classification information storage unit 108, and selects the type of defect for which the defect rate is to be compared (S901). FIG. 10 depicts an example of the classification information stored in the classification information storage unit 108 according to the present example embodiment of the present invention. In the classification information according to the present example embodiment, set values are associated with a type of defect requiring extra caution or a type of defect that is likely to occur when image forming and outputting processes are performed with the set value set in the setting information.

As depicted in FIG. 10, for example, the type of defect “tone failure” is associated with the set value “full color” because the tone of the original image data may be different from the tone of the image scanned from paper on which an image is formed. Moreover, the type of defect “misregistration” is associated with the set value “duplex” because the printing position may be misregistered due to the processes of reversing paper. Further, the type of defect “streaking” is associated with the set value “photo paper” because streaking failure tends to stand out when a photographic image including solid fill is formed on photo paper.

In the classification information depicted in FIG. 10, the types of defect are listed in descending order of priority. When the setting information indicates a plurality of settings, the selection unit 109 refers to the classification information, and specifies that one of the categories whose priority level is the highest, among the categories associated with the settings indicated by the setting information, is the category that corresponds to the settings. For example, when the setting information includes “full color”, “duplex”, and “plain paper”, the selection unit 109 obtains the type of defect “tone failure” as a type of defect requiring extra caution or a type of defect that is likely to occur, i.e., as the type of defect for which the defect rate is to be compared, because the type of defect “tone failure” has the highest priority in the classification information depicted in FIG. 10.

Then, the selection unit 109 refers to the defect rate information stored in the defect rate information storage unit 107 to compare the defect rates of the type of defect to be compared among a plurality of printer IDs, and obtains the printer ID whose defect rate is the smallest from those printer IDs (S902). By performing these processes as described above, the selection unit 109 selects the image forming apparatus 2 corresponding to the obtained printer ID as the image forming apparatus 2 that is to perform image forming and outputting processes based on the print job received by the receiving unit 103.

For example, when the type of defect obtained in S901 is “tone failure”, the selection unit 109 refers to the defect rate information depicted in FIG. 6 to compare the defect rates of “tone failure” with each other among printer IDs, and obtains the printer ID “P02” whose defect rate is the smallest. In the defect rate information depicted in FIG. 6, the mean defect rate of all the types of defect is smaller with the printer ID “P01” than with the printer ID “P02”. However, the image forming apparatus 2 of the printer ID “P02” having the smallest defect rate in “tone failure” is selected as described above according to the setting information of the print job to be executed. When there are two or more printer IDs that have the smallest defect rate, the selection unit 109 may select any one of the printer IDs.

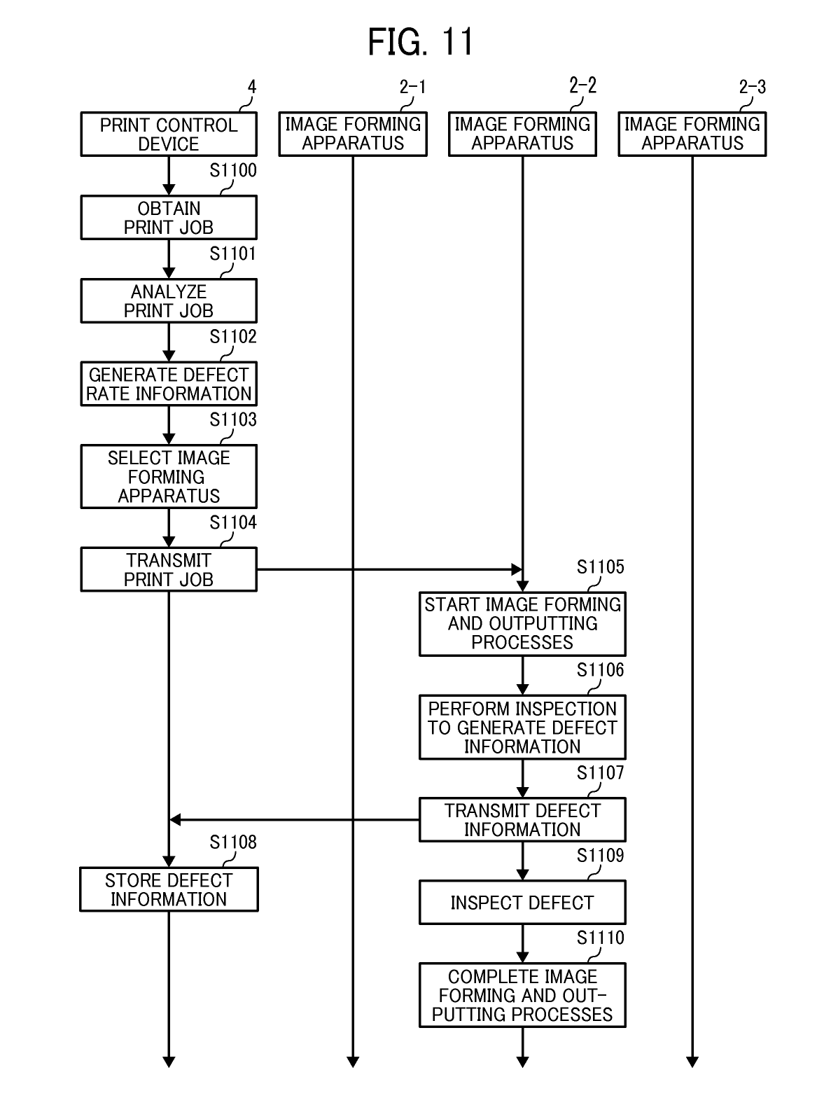

Next, the operation of the image forming system 5 according to an example embodiment of the present invention is described with reference to FIG. 11. FIG. 11 is a sequence diagram illustrating the operation of the image forming system 5 according to the present example embodiment of the present invention. In the description below with reference to FIG. 11, cases in which the print control device 4 and three image forming apparatuses (i.e., the image forming apparatuses 2-1 to 2-3) are connected to each other through the network are described, but the number of the image forming apparatuses 2 is not limited to this configuration.

As illustrated in FIG. 11, the print control device 4 receives a print job from the information processing device 1 (S1100). The print control device 4 that has received the print job analyzes the received print job (S1101). As a result, the print control device 4 obtains, for example, the threshold defect level “3”, and the set values of “full color”, “duplex printing”, and “plain paper” as the setting information.

After analyzing the print job, the print control device 4 calculates a defect rate equal to or greater than the threshold defect level “3”, which is obtained from the analytical results, for each type of defect and for each of the image forming apparatuses 2-1 to 2-3, to generate defect rate information (S1102). As a result, the print control device 4 generates, for example, the defect rate information as depicted in FIG. 6.

After generating the defect rate information, the print control device 4 selects the image forming apparatus 2 that is to perform the image forming and outputting processes based on the print job received from the information processing device 1, according to the setting information obtained from the analytical results, the generated defect rate information, and the classification information (S1103). Because the set values in the setting information include “full color”, “duplex”, and “plain paper” and the types of defect associated with these set values in the classification information depicted in FIG. 10 are “tone failure”, “misregistration”, and “stain”, respectively, the print control device 4 obtains “tone failure” that has the highest priority, as the type of defect for which the defect rate is to be compared. Then, the print control device 4 refers to the defect rate information depicted in FIG. 6, and selects the image forming apparatus 2-2 of the printer ID “P02” having the smallest defect rate for “tone failure”.

After selecting the image forming apparatus 2-2, the print control device 4 transmits the print job received from the information processing device 1 to the selected image forming apparatus 2-2 (S1104).

The image forming apparatus 2-2 receives the print job from the print control device 4, and starts image forming and outputting processes based on the received print job (S1105). After starting image forming and outputting processes, the image forming apparatus 2-2 uses the inspection device 3-2 to inspect the output results based on a threshold for generating defect information, and generates defect information (S1106). After generating the defect information, the image forming apparatus 2-2 transmits the generated defect information to the print control device 4 (S1107).

The print control device 4 receives the defect information from the image forming apparatus 2-2, and stores the received defect information in the defect information storage unit 102 (S1108).

After transmitting the defect information to the print control device 4, the image forming apparatus 2-2 uses the inspection device 3-2 to inspect a defect of the output results based on a threshold that corresponds to the threshold defect level specified by the received print job, and performs re-printing according to the result of the inspection (S1109). After performing defect inspection and re-printing according to the results of the inspection, the print control device 4 completes the image forming and outputting processes based on the received print job (S1110).

As described above, in the image forming system 5 according to the present example embodiment, the print control device 4 obtains the type of defect associated with the set value of the setting information that is included in the print job sent from the information processing device 1, and selects the image forming apparatus 2 having the smallest defect rate for the type of defect obtained from the defect rate information in which the defect rate is summarized for each type of defect for each of the image forming apparatuses 2. As a result, the selected image forming apparatus 2 can perform image forming and outputting processes based on the print job sent from the information processing device 1. Accordingly, not just a defect rate calculated when image forming and outputting processes are performed by the image forming apparatus 2 (type of defect is not taken into consideration in such a defect rate) is referred to select the image forming apparatus 2, but the image forming apparatus 2 having the smallest defect rate for a particular type of defect that is likely to occur when image forming and outputting processes are performed with the setting information included in the print job is selected. As a result, it is possible to select one of the image forming apparatuses 2 that produces printed materials with the least number of defects, according to a print job.

Moreover, in the image forming system 5 according to the present example embodiment described above, the defect rate information is generated from the defect information where each defect is summarized for a unit of defect, which is sent from the image forming apparatuses 2, based on the result of determination made according to the threshold defect level specified in the print job. As a result, the image forming apparatus 2 is selected according to the defect rate that is calculated in accordance with the threshold defect level specified in the print job. Accordingly, it is possible to more precisely select one of the image forming apparatuses 2 that produces printed materials with the least number of defects, which are equal to or greater than that threshold defect level.

### First Modification

In the example embodiment as described above, defect rate information is generated based on a result of determination made according to a threshold defect level. However, no limitation is indicated therein, and when determination is made according to a uniform threshold defect level (i.e., a fixed threshold) that does not differ depending on a print job, defect rate information may be generated in advance according to that fixed threshold.

### Second Modification

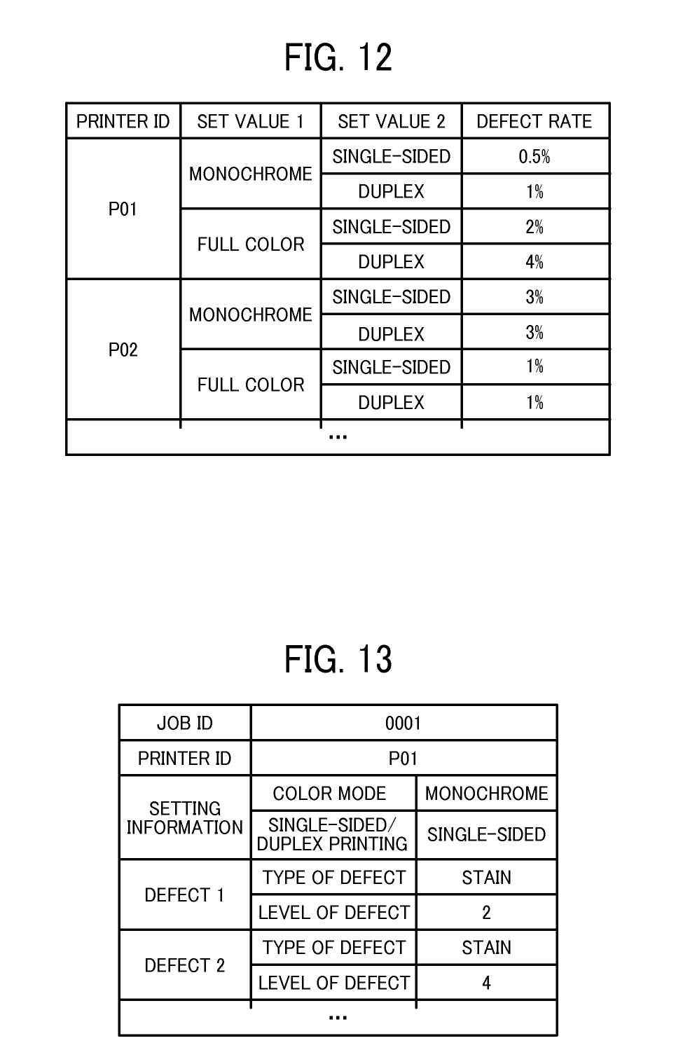

In the example embodiment described above, cases in which a defect rate for each type of defect is calculated for each of the image forming apparatuses 2 to generate defect rate information are described. However, no limitation is indicated therein, and a defect rate for each set value of the setting information or for each combination of two or more set values of the setting information may be calculated for each of the image forming apparatuses 2 to generate defect rate information. In other words, the category described above may be defined by set values of image forming or combinations of these set values, instead of types of defect. FIG. 12 depicts an example of the defect rate information in which defect rates for each combination of set values are calculated for each of the image forming apparatuses 2, according to a second modification of the present invention. For example, when the setting consist of two items of “color mode” and “single-sided/duplex printing”, the set values has four combinations of “monochrome/single-sided”, “monochrome/duplex”, “full color/single-sided”, and “full color/duplex”. Accordingly, as depicted in FIG. 12, defect rate information is generated by calculating defect rates for four combinations for each of the image forming apparatuses 2. In other words, the defect rate information generator 106 generates defect rate information by summing up the number of the defects indicated by the obtained defect information for each of the set values of image forming or each of the combinations of the set values, for each of the image forming apparatuses 2, and by dividing the summed up value by the total number of times images have been formed by that image forming apparatus 2.

In the second modification, the defect rate information generator 106 refers to the defect information stored in the defect information storage unit 102, and calculates a defect rate for each of the image forming apparatuses 2 according to the number of the defects in a print job where the combination of the set values of print setting included in the defect information is the same. Then, the selection unit 109 refers to the defect rate information stored in the defect rate information storage unit 107 to compare the defect rates with the combination same as the combination of set values specified by the setting information sent from the analyzer 104, and selects the image forming apparatus 2 having the printer ID whose defect rate is the smallest.

For example, when the combination of set values specified by the setting information sent from the analyzer 104 is “full color, duplex”, the image forming apparatus 2 having the printer ID “P02” whose defect rate with the combination of “full color, duplex” is the smallest is selected from the image forming apparatuses 2 indicated by the defect rate information of FIG. 12. Thus, according to the second modification as described above, it is possible to select one of the image forming apparatuses 2 that produces printed materials with the least number of defects, according to a print job sent from the information processing device 1.

### Third Modification

In the example embodiment described above, cases in which elements of defect given for each unit of defect as depicted in FIG. 4 are included in the defect information stored in the defect information storage unit 102 were described. However, no limitation is indicated therein, and the elements of defect may be the type of defect and the level of defect. The level of defect indicates the degree of each defect.

FIG. 13 depicts an example of the defect rate information including the type of defect and the level of defect for each unit of defect, according to a third modification of the present invention. For example, when the type of defect of the first unit of defect (DEFECT 1) is determined to be stain and the area of the stain indicating the degree of the defect is “60”, the defect level is determined to be “2” if the threshold characteristic amount information depicted in FIG. 8 is applied thereto.

In the third modification, the defect rate information generator 106 compares the threshold defect level sent from the analyzer 104 with the defect level included in the defect information, and when threshold defect level is greater than the defect level, it is determined that the defect is not defective. On the other hand, when the threshold level is equal to or less than the defect level, it is determined that the defect is defective, and the defect rate information generator 106 increases the number of the times that type of defect has occurred by one. For example, when the threshold defect level sent from the analyzer 104 is “3”, “stain” of the defect 1 as depicted in FIG. 13 is determined to be not defective as threshold defect level is greater than the defect level. On the other hand, “stain” of the defect 2 is determined to be defective as threshold defect level is equal to or less than the defect level, and the defect 2 is counted as the number of the times the defect of “stain” has occurred with reference to this threshold defect level.

In other words, the defect rate information generator 106 generates defect rate information according to the obtained defect information and the threshold defect level. More specifically, the defect rate information generator 106 generates defect rate information by summing up the number of the defects whose defect levels are equal to or greater than the threshold defect level, which are indicated by the obtained defect information, for each of the image forming apparatuses 2 and for each category of defect, and by dividing the summed up value by the total number of times images have been formed by that image forming apparatus 2.

Due to such a configuration as described above, the amount of the data stored in the defect information storage unit 102 can be reduced, and the computational complexity in determination processes can also be reduced as all that is required is to compare a threshold defect level with a defect level. Alternatively, the defect rate information generator 106 may calculate a defect rate for each combination of set values as depicted in FIG. 12 by referring to the defect information depicted in FIG. 13.

### Fourth Modification

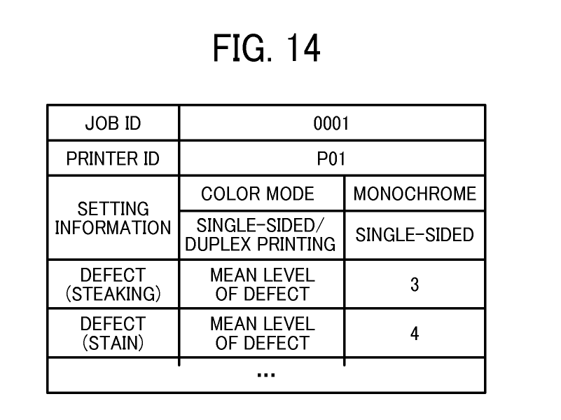

Alternatively, the detail of defect may be a mean defect level calculated for each type of defect. FIG. 14 depicts an example of defect information in which a mean defect level is listed for each type of defect, according to a fourth modification of the present invention. For example, in the defect information as illustrated in FIG. 14, the mean defect level “3” is listed for the type of defect “streaking”, and the mean defect level “4” is listed for the type of defect “stain”.

In the third modification, the defect rate information generator 106 compares the threshold defect level sent from the analyzer 104 with the mean defect level included in the defect information, and when threshold defect level is greater than the mean defect level, it is determined that the defect is not defective. On the other hand, when the threshold level is equal to or less than the mean defect level, it is determined that the defect is defective, and the defect rate information generator 106 increases the number of the times that type of defect has occurred by one.

In other words, the defect rate information generator 106 generates defect rate information according to the obtained defect information and the threshold defect level. More specifically, the defect rate information generator 106 generates defect rate information by summing up the number of the defects whose mean defect levels are equal to or greater than the threshold defect level, which are indicated by the obtained defect information, for each of the image forming apparatuses 2 and for each category of defect, and by dividing the summed up value by the total number of times images have been formed by that image forming apparatus 2.

Due to such a configuration as described above, the amount of the data stored in the defect information storage unit 102 can further be reduced, and the computational complexity in determination processes can also be reduced as all that is required is to compare a threshold defect level with a mean defect level. Alternatively, the defect rate information generator 106 may calculate a defect rate for each combination of set values as depicted in FIG. 12 by referring to the defect information depicted in FIG. 14.

### Fifth Modification

In the example embodiment described above, cases in which the set values of print setting are associated with types of defect on a one-by-one basis in the classification information stored in the classification information storage unit 108 and these associated set values and types of defect are listed in descending order of priority were described. However, such a configuration is merely an example and no limitation is indicated therein. For example, the priority levels may be stored in a different storage medium as separate information. Further, a combination of a plurality of set values may be associated with a type of defect in the classification information. Alternatively, when a default type of defect (e.g., “stain”) is determined in advance but it is desired that a different type of defect be associated, a set value may be associated with such a different type of defect in the classification information.

### Sixth Modification

In the example embodiment described above, cases in which when a plurality of set values are present in a print job, the selection unit 109 selects a single type of defect based on the priority levels defined in the classification information were described. However, such a configuration is merely an example and no limitation is indicated therein. When a plurality of set values are present in a print job, the selection unit 109 may select the image forming apparatus 2 having the smallest sum of the defect rates of the types of defect that are associated with these set values. The sum may be calculated from the defect rates that are weighted among the types of defect associated with those set values.

### Seventh Modification

In the example embodiment described above, cases in which when there are two or more printer IDs that have the smallest defect rate, the selection unit 109 selects any one of the printer IDs were described. Alternatively, when there are two or more printer IDs that have the smallest defect rate, the selection unit 109 may select the printer ID that has the smallest sum of the defect rates for the other types of defect from among these printer IDs, or may select the printer ID that has the smallest defect rate for another type of defect that is associated with the set value. Alternatively, the selection unit 109 may narrow the printer IDs according to the distance between the image forming apparatus 2 and the information processing device that has transmitted a print job, or the line speed of the network.

### Eighth Modification

In the example embodiment described above, cases in which the print control device 4 includes the threshold characteristic amount information storage unit 105 and the classification information storage unit 108 were described. However, the threshold characteristic amount information storage unit 105 and the classification information storage unit 108 may be disposed outside the print control device 4 as long as the image forming apparatus 2 is selected according to the setting information of the received print job.

For example, the threshold characteristic amount information storage unit 105 and the classification information storage unit 108 may be provided for a server or the like that is connected to the print control device 4 through the network, and the print control device 4 can perform processes equivalent to those of the example embodiment described above by accessing such a server or the like through the network to access the threshold characteristic amount information or classification information.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc. Alternatively, any one of the above-described and other methods of the present invention may be implemented by ASICs, prepared by interconnecting an appropriate network of conventional component circuits, or by a combination thereof with one or more conventional general-purpose microprocessors and/or signal processors programmed accordingly.

What is claimed is:

1. A selection device comprising:
a data obtainer configured to obtain defect information indicating defect on an output result of image forming, from each of a plurality of image forming apparatuses;
a receiver configured to receive an image formation instruction;
a defect rate information generator configured to generate defect rate information based on the obtained defect information and the image formation instruction, the generated defect rate information indicating a rate of occurrence of a defect by category of defect for each of the image forming apparatuses; and
a selector configured to specify a category corresponding to the image formation instruction, and to select one of the image forming apparatuses that is to perform image forming based on the image formation instruction, according to the defect rate information corresponding to the specified category.

2. The selection device according to claim 1, further comprising: a transmission unit configured to transmit the image formation instruction to the selected image forming apparatus.

3. The selection device according to claim 1, wherein
the defect information includes an identifier for identifying the image forming apparatus that generates an output causing the defect, and a type of defect and characteristics of the defect for each defect, and
the defect rate information generator calculates, for each of the image forming apparatuses, a sum of the number of defects indicated by the obtained defect information for each category of defect, and divides the sum by a total number of times images are formed by the image forming apparatus.

4. The selection device according to claim 1, wherein the defect information includes an identifier for identifying the image forming apparatus that generates an output causing the defect, and a type of defect and characteristics of the defect for each defect,
the image formation instruction includes a threshold defect level indicating a threshold for determining a defect level to be defective from a plurality of defect levels, and
the defect rate information generator obtains threshold characteristic amount information in which for each type of defect each of the defect levels is associated with a threshold characteristic amount indicating a threshold amount of characteristic for determining whether that defect level is defective, and generates the defect rate information according to the obtained defect information, the threshold defect level, and the threshold characteristic amount information.

5. The selection device according to claim 4, wherein the defect rate information generator calculates, for each of the image forming apparatuses, a sum of the number of defects whose defect levels specified by the threshold characteristic amount information are equal to or greater than the threshold defect level among the defects indicated by the obtained defect information, for each category of defect, and divides the sum by a total number of times images are formed by the image forming apparatus.

6. The selection device according to claim 1, wherein
the defect information includes, for each defect, an identifier for identifying the image forming apparatus that generates an output causing the defect, a type of defect, and a defect level of the defect,
the image formation instruction includes a threshold defect level indicating a threshold for determining a defect level to be defective from a plurality of defect levels, and
the defect rate information generator generates the defect rate information according to the obtained defect information and the threshold defect level.

7. The selection device according to claim 6, wherein the defect rate information generator calculates, for each of the image forming apparatuses, a sum of the number of defects whose defect levels are equal to or greater than the threshold defect level among the defects indicated by the obtained defect information, for each category of defect, and divides the sum by a total number of times images are formed by the image forming apparatus.

8. The selection device according to claim 1, wherein
the defect information includes an identifier for identifying the image forming apparatus that generates an output causing the defect, and a mean defect level calculated for each type of defect,
the image formation instruction includes a threshold defect level indicating a threshold for determining a defect level to be defective from a plurality of defect levels, and the defect rate information generator generates the defect rate information according to the obtained defect information and the threshold defect level.

9. The selection device according to claim 8, wherein the defect rate information generator calculates, for each of the image forming apparatuses, a sum of the number of defects whose mean defect levels are equal to or greater than the threshold defect level among the defects indicated by the obtained defect information, for each category of defect, and divides the sum by a total number of times images are formed by the image forming apparatus.

10. The selection device according to claim 1, wherein
the image formation instruction includes image forming and outputting setting information, and
the selector obtains classification information that associates image forming and outputting setting with categories, and specifies a category associated with setting indicated by the setting information using the obtained classification information.

11. The selection device according to claim 10, wherein the selector refers to the classification information, and specifies that a category associated with setting indicated by the setting information is a category corresponding to the setting.

12. The selection device according to claim 10, wherein
the classification information has a priority level given to the category, and
when the setting information indicates a plurality of settings, the selector refers to the classification information, and specifies that one of a plurality of categories whose priority level is highest, among the categories associated with the settings indicated by the setting information, is a category associated with the settings.

13. The selection device according to claim 1, wherein the selector refers to the defect rate information, and selects one of the image forming apparatuses where a rate of occurrence of defects of the specified category is lowest.

14. The selection device according to claim 1, wherein the category is a type of defect.

15. The selection device according to claim 1, wherein
the category is a setting of image forming,
the defect information includes an identifier for identifying the image forming apparatus that generates an output causing the defect, setting information of image forming responsible for generation of the defect information, and information specifying a number of defects,
the defect rate information generator calculates, for each of the image forming apparatuses, a sum of the number of defects for each setting of the image forming using the obtained defect information, and divides the sum by a total number of times images are formed by the image forming apparatus,
the image formation instruction includes setting information of image forming to be performed based on the image formation instruction, and
the selector selects setting indicted by the setting information included in the image formation instruction for a setting of image forming specified by the image formation instruction.

16. An image forming system comprising:
a plurality of defect information generators each configured to generate defect information of a defect on an output result of image forming performed by each of a plurality of image forming apparatuses;
a receiver configured to receive an image formation instruction;
a defect rate information generator configured to generate defect rate information based on the generated defect information and the image formation instruction, the generated defect rate information indicating a rate of occurrence of a defect by category of defect for each of the image forming apparatuses; and
a selector configured to specify a category corresponding to the image formation instruction, and to select one of the image forming apparatuses that is to perform image forming based on the image formation instruction, according to the defect rate information corresponding to the specified category.

17. A selection method comprising:
obtaining defect information of defect on an output result of image forming, from each of a plurality of image forming apparatuses;
receiving an image formation instruction;
generating defect rate information based on the obtained defect information and the image formation instruction, the generated defect rate information indicating a rate of occurrence of a defect by category of defect for each of the image forming apparatuses; and
specifying a category corresponding to the image formation instruction, and selecting one of the image forming apparatuses that is to perform image forming based on the image formation instruction, according to the defect rate information corresponding to the specified category.
